(19) United States
(12) Patent Application Publication
(10) Pub. No.: US 2002/0002458 A1
(43) Pub. Date: Jan. 3, 2002

(54) SYSTEM AND METHOD FOR REPRESENTING COMPLEX INFORMATION AUDITORIALLY

(76) Inventors: DAVID E. OWEN, WATERTOWN, MA (US); EDMUND R. MACKENTY, WATERTOWN, MA (US); MARSHALL CLEMENS, LINCOLN, MA (US)

Correspondence Address: TESTA, HURWITZ & THIBEAULT, LLP, HIGH STREET TOWER, 125 HIGH STREET, BOSTON, MA, 02110, US

(21) Appl. No.: 08/956,238

(22) Filed: Oct. 22, 1997

(51) Int. Cl. G10L 13/00

(52) U.S. Cl. 704/260

(57) ABSTRACT

A method for representing information auditorially begins by receiving a concept set representing information. That concept set is mapped to a semantic element stored in a memory element. The semantic element is used to select a command identifying a sound to be output. The command is executed to output the identified sound. A related apparatus for representing information auditorially includes a mapping unit and a command execution unit. The mapping unit accepts as input a concept set representing information. The mapping unit outputs a command identifier indicating a command to be executed based on the concept set. The command execution unit accepts the command identifier and executes the identified command. In some embodiments, the apparatus includes a sound player for outputting audio data. in other embodiments the apparatus include a semantic framework design unit for editing the semantic elements. In still another embodiment the apparatus include a sound palette editor for editing the sound definition files in the sound palette.

### FIELD OF THE INVENTION

The present invention relates to systems for displaying information and, in particular, to systems that represent complex information auditorially.

### BACKGROUND OF THE INVENTION

Auditory display, sometimes referred to as “sonification,” generally refers to presenting information using non-speech sound, and is part of the user interface design field. Research has demonstrated that human hearing facilities are proficient at monitoring trends or relationships in multiple sets of rapidly-changing data sets.

Allowing users to efficiently monitor multiple, rapidly-changing data sets has ramifications for many industries, such as financial instrument trading and process control, as those industries become heavily computerized. Further, an auditory user interface would allow visually-challenged individuals access to wide variety of information and services to which they currently do not have access because of the visual bias in the computer user interface paradigm. Currently, a computer's “user interface” generally refers to a limited number of standard input devices, e.g. a keyboard, mouse, trackball, or touch pad, and a single output device, e.g. a display screen.

### SUMMARY OF THE INVENTION

The invention provides computer programs with a way to present complex information to the user auditorially, instead of visually. The use of sound to present simple information about the occurrence of events is well known: computers beep when the user makes a mistake, for example. But by carefully organizing sets of sounds so that they convey semantic content, more complex information can be conveyed, such as (1) an error has been encountered attempting to save a (2) text document, which is (3) fully compressed, because it is (4) 3% greater than the available hard disk space.

In one aspect, the present invention relates to a method for representing information auditorially. A concept set is generated representing information. That concept set is mapped to a semantic element stored in a memory element. The semantic element is used to select a command identifying a sound to be output. The command is executed to output the identified sound.

In another aspect, the present invention relates to an apparatus for representing information auditorially which includes a mapping unit and a command execution unit. The mapping unit accepts as input a concept set representing information. The mapping unit outputs a command identifier indicating a command to be executed based on the concept set. The command execution unit accepts the command identifier and executes the identified command. In some embodiments, the apparatus includes a sound player for outputting audio data. In other embodiments the apparatus includes a semantic framework design unit for editing the semantic elements. In still another embodiment the apparatus includes a sound palette editor for editing the sound definition files in the sound palette.

### BRIEF DESCRIPTION OF THE DRAWINGS

The invention is pointed out with particularity in the appended claims. The advantages of the invention described above, as well as further advantages of the invention, may be better understood by reference to the following description taken in conjunction with the accompanying drawings, in which:

FIG. 1 is a diagrammatic representation of a three-dimensional semantic framework;

FIG. 2 is a block diagram of an embodiment of the Auditory Display Manager;

FIG. 3 is a diagrammatic representation of an embodiment of the present invention in which the semantic framework is implemented as a hash table;

FIG. 4 is a diagrammatic view of an embodiment of the semantic element data structure;

FIG. 5 is a diagrammatic view of an embodiment of the sound palette data structure;

FIG. 6 is a diagrammatic view of an embodiment of the sound definition data structure;

FIG. 7 is a diagrammatic view of an embodiment of the semantic framework lookup process;

FIG. 8 is a diagrammatic view of an embodiment of the sound player queues; and

FIG. 9 is a diagrammatic view of an embodiment of the playback data structure.

### DETAILED DESCRIPTION OF THE INVENTION

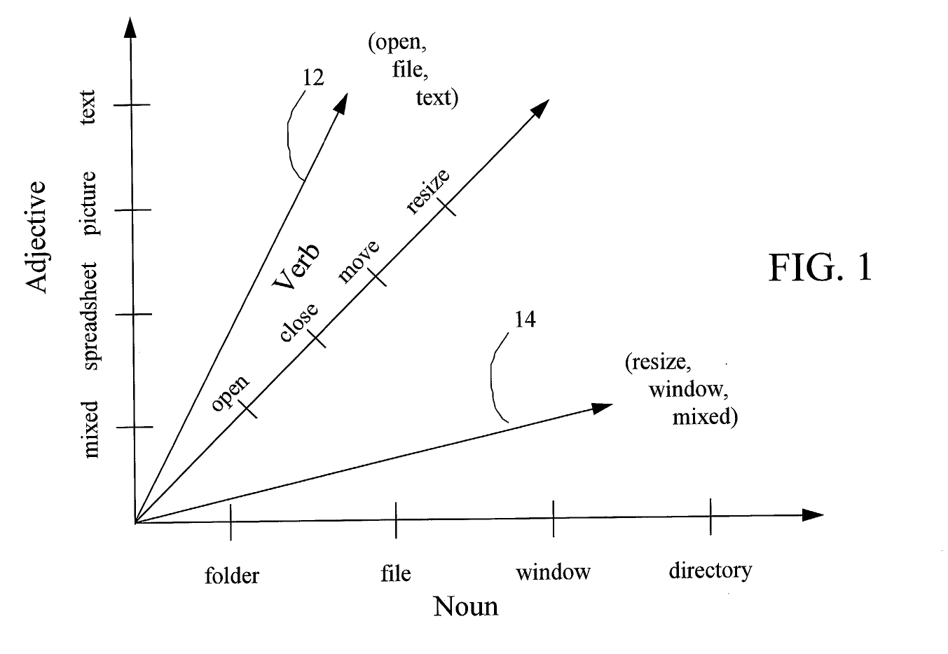

In brief overview, the present invention is based on an n-dimensional array organization, each element of which may contain instructions for creating or controlling a set of sounds. Each dimension of the array represents a concept and information is represented by the combination of those concepts. For example, FIG. 1 shows an embodiment in which there are three dimensions: noun, verb, and adjective. Each point in the n-dimensional array represents a specific instance of a concept. The point of intersection of the vectors for a particular set of concepts contains information about how to represent that conceptual combination auditorially: that is, what sounds should be used and how they should be controlled. For example, a first vector 12 shown in FIG. 1 identifies an entry used to indicate opening a text file. A second vector 14 in the n-dimensional array space identifies an entry used to indicate resizing a window containing a mixture of file types. The n-dimensional array represents semantic structure and is referred to throughout this document as a “semantic framework.”

Each vector in a semantic framework represents a specific combination of structural elements which represents a specific concept, i.e. a simple sentence. Referring to the example shown in FIG. 1, nouns could describe the various objects about which a computer must inform the user, such as “folder,” “file,” “window,” “directory ,” “cell” (not shown), “data value” (not shown), “telephone call” (not shown) or any other element. Verbs could describe the various actions that the system can perform on the objects. FIG. 1 shows four exemplary verbs: “open;” “close;” “move;” and “resize.” FIG. 1 depicts a semantic framework having a third dimension representing adjectives. Sample adjectives include “mixed,” “spreadsheet,” “picture,” and “text.” Entries in the n-dimensional space represent simple sentences such as “open picture file,” “open text file” 12, or “resize mixed window” 14. Meaningless combinations, such as “close spreadsheet directory” or “open telephone call,” could be left undefined so that they have no representation in the semantic framework. Alternatively, meaningless combinations could be assigned an entry indicating that a condition has occurred resulting in the generation of a meaningless sentence.

There may be several semantic frameworks of the sort depicted in FIG. 1 simultaneously active. In one embodiment, semantic frameworks are organized in a tree structure, in which the root semantic framework defines general-purpose concepts and the branches define progressively more specific concepts. Continuing the simple language-like example used above, a typical multi-processing system would have entries in the root semantic framework for things that any application might do, e.g. “rename” a “file,” and each particular application might have its own semantic framework with entries for things that are unique to the application, e.g. “paint” using an “airbrush.” In this embodiment, entries in more specific semantic frameworks take precedence over entries in more general semantic frameworks, allowing entries in one semantic framework to override identical entries in another. Regardless of the organization of multiple semantic frameworks, all active semantic frameworks must have the same number of dimensions and each dimension must have the same meaning or purpose.

A program constructs a “concept set” in order to use an active semantic framework. A concept set is a set of text strings that specify values for each semantic framework dimension. Concept sets may also specify modifiers, but modifiers are optional. The concept set is used to select a particular element within a semantic framework. The modifiers can be used to select variants within that element. For example, referring back to FIG. 1, a concept set might consist of “open”, “file”, “text” and specify a modifier of “list.txt.” This concept set would indicate that the program generating the concept set is opening a text file named “list.txt.” The semantic element for the verb “open”, the noun “file” and the adjective “text” specifies how the system should auditorially represent opening a text file. Additionally, the modifier “list.txt” could indicate a modification to the sound used to represent this event. In one embodiment, the name of the file may be spoken using a text-to-speech device. In another embodiment, common sound modifications such as vibrato, phase shift, or chorus may be assigned to common file names, e.g. list.txt, config.sys, paper.doc, to indicate that those files are the subject of the event represented by the sound.

As a further example, an application could inform the user that a fully compressed text document named “paper.txt” could not be saved because it is 3% larger than the available space on disk. The application could construct a concept set specifying values for four dimensions; an event (“error” or “success”), an object (“text document”), “image document”, “menu”, etc.), an error type (“diskfuill”, “disk error”, “nonexistent file”, “file already exists”, etc.), and a compression level (“full”, “none”, or “quick”); and two modifiers: document name (“paper.txt”) and overflow value (“3%”). To represent that a fully compressed text document cannot be saved because it exceeds available disk space by three percent, the application would construct a concept set with the appropriate values for each dimension (i.e. “error”, “text document”, “disk full”, and “full”) that would select a semantic element from the semantic framework that specifies commands that cause one or more sounds or effects to be generated conveying this information to the user auditorially.

The concept set comprises the primary interface between applications and the Auditory Display Manager and is the representation of the meaning of an event within the system. Concept sets can describe momentary events or events with arbitrary duration. An event of arbitrary duration can be represented using two concept sets: one to start a sound playing at the beginning of an event and another to stop the sound at the end of an event.

The multi-dimensional nature of the semantic framework simplifies the creation of similarities between sounds produced in response to concept sets that share a particular concept. For example: sounds for all concept sets using a particular noun could use the same musical instrument, so that the user associates that instrument with the noun; and all concept sets using a particular verb could use the same melody. In this manner the combination of a melody and an instrument can directly represent the identity of the noun and verb, i.e. semantic content, to the user.

In order to present an harmonious auditory display that is intelligible to the user, the set of sounds representing individual concepts in each dimension of the semantic framework must be chosen so that the sounds complement each other. This set of sounds is referred to as a “sound palette.” Like a painter's palette, the sound palette contains the range of sounds that may be used together at any one time. Each sound in a sound palette is named, and the data used to produce the sound is associated with that name. Sound palettes may contain sounds which are combinations of other sounds within the palette.

Several sound palettes may be created for the same semantic framework, allowing a user to select from a number of sets of well-organized sounds. Different sound palettes would have different characters, and some individuals would prefer certain kinds of sounds over others. The ability to change sound palettes, without changing the semantic framework itself, allows the user to customize the auditory display.

In order to represent the modifiers in concept sets, sounds need to be modified in various ways. Concept sets can also be defined that alter sounds that are already playing (e.g. changing the volume), so a set of methods is provided for modifying sounds. In the preferred embodiment, these would include altering the pitch, altering the volume, playing two or more sounds in sequence, playing a sound backwards, looping a sound repeatedly, and stopping a sound that is playing.

In order to prevent cacophony when many events occur near to each other in time, a set of methods is provided for organizing the sound playback. Sounds may play in parallel, that is, overlap each other in time, or they may play in series, one after the other. Parallel sounds are appropriate for events whose time of occurrence is important. Serial sounds are appropriate when only the occurrence of an event is important and not the exact timing of the occurrence. Sounds may also be synchronized to a discrete time function, creating a rhythm or beat on which all sounds are played. This allows for the presentation of a more musical auditory display. By carefully constructing the semantic framework and sound palette, it is possible to create a song-like auditory display in which important events that require the user's attention become the melody and less-important events are the background, or rhythm, section.

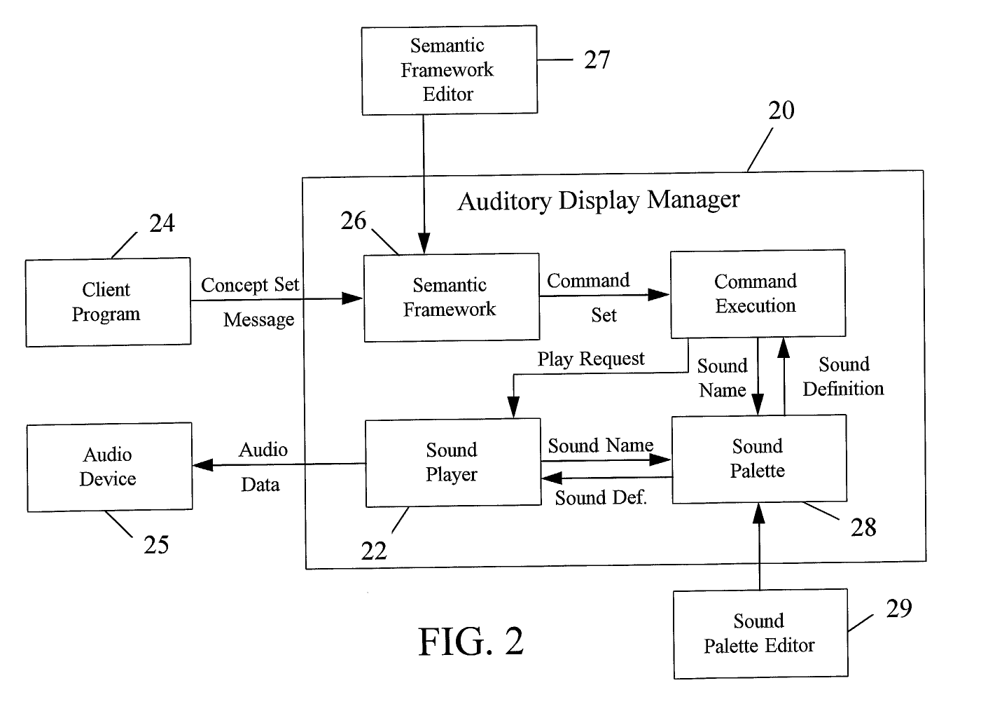

FIG. 2 depicts an embodiment of the system for representing complex information auditorially. A software module 20 provides the service of controlling the auditory display for other software modules within a computer system, such as a client program 24. The software module 20 will sometimes be referred to as the Auditory Display Manager (ADM). The client/server architecture depicted in FIG. 2 is well known and widely used in the software industry.

Client programs 24 communicate with the ADM 20 using communication methods that depend on the computer system on which the ADM 20 is implemented. A client program 24 sends a message to the ADM 20 which identifies the operation the client program 24 wants the ADM 20 to perform. The message may also contain data which the ADM 20 requires to perform the specified operation. The ADM 20 executes the operation specified by the message. The ADM 20 may send a message back to the client program 24 containing a response.

Structure of the Semantic Framework

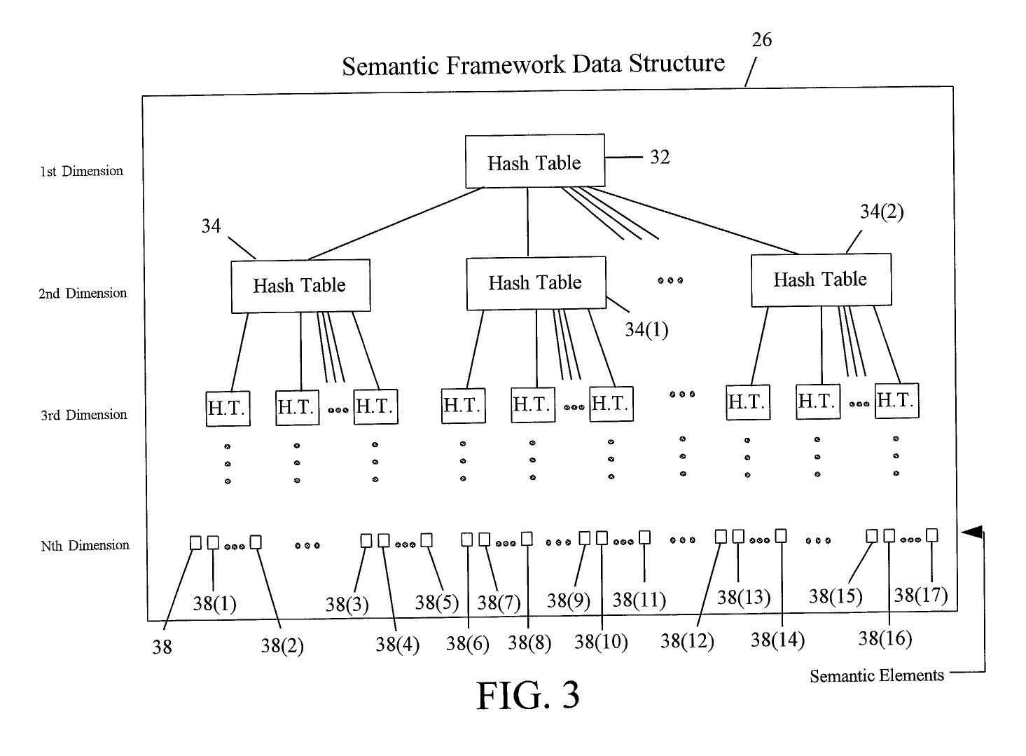

A semantic framework 26 can be represented by any data structure which provides efficient storage of large data structures having many undefined elements. The selected data structure should also be easily resized as additional elements are defined or removed from the structure. A semantic framework 26 can be implemented as an n-dimensional sparse array indexed by strings. Referring to FIG. 3, the n-dimensional sparse array, i.e. the semantic framework 26, can be implemented using a tree of hash tables. Any simple, well-known hashing algorithm can be used to locate individual semantic elements within the tree of hash tables. The root hash table 32 of the tree represents a first dimension of the array. Each item in that hash table refers to a second hash table 34, 34(1), 34(2) representing the next dimension of the array. This process continues for each dimension of the array. The hash tables for the last dimension of the array contain the semantic elements 38, 38(1), 38(2), 38(3), 38(4), 38(5), 38(6), 38(7), 38(8), 38(9), 38(10), 38(11), 38(12), 38(13), 38(14), 38(15), 38(16), 38(17).

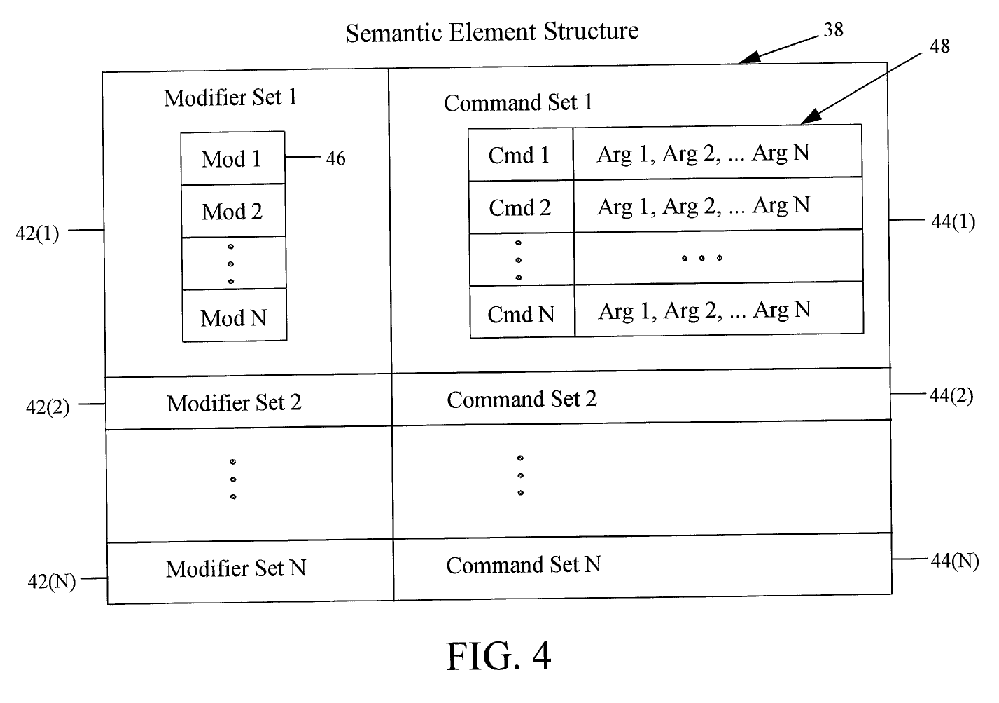

Referring to FIG. 4, semantic elements 38 may be implemented as a table that lists modifier sets 42(1), 42(2), 42(N) and associates them with a command set to be performed 44(1), 44(2), 44(N). Each modifier set can be a list 46 of zero or more character strings. The modifier set should be organized in some fashion that allows modifier sets 46 to be efficiently compared to modifier strings received from a concept set to select a command set to execute in response to the concept set. For example, modifier lists 46 may be ordered alphabetically. Additionally, there should be no duplicate modifiers within a modifier set 46 and no duplicate modifier sets 46.

A command set 48 is a list of zero or more command names and command arguments, all of which can be represented as simple text strings. For example, commands may include at least the following command shown in Table 1 below:

### Table 1

Command arguments may refer to modifiers contained in the concept set by their position in the concept set. This allows the value for the argument to be taken from a specific modifier in the concept set instead of using the value of the argument from the command set. If the command argument refers to a non-existent modifier, then the command is not performed, but any other commands in the list may be performed.

Structure of the Sound Palette

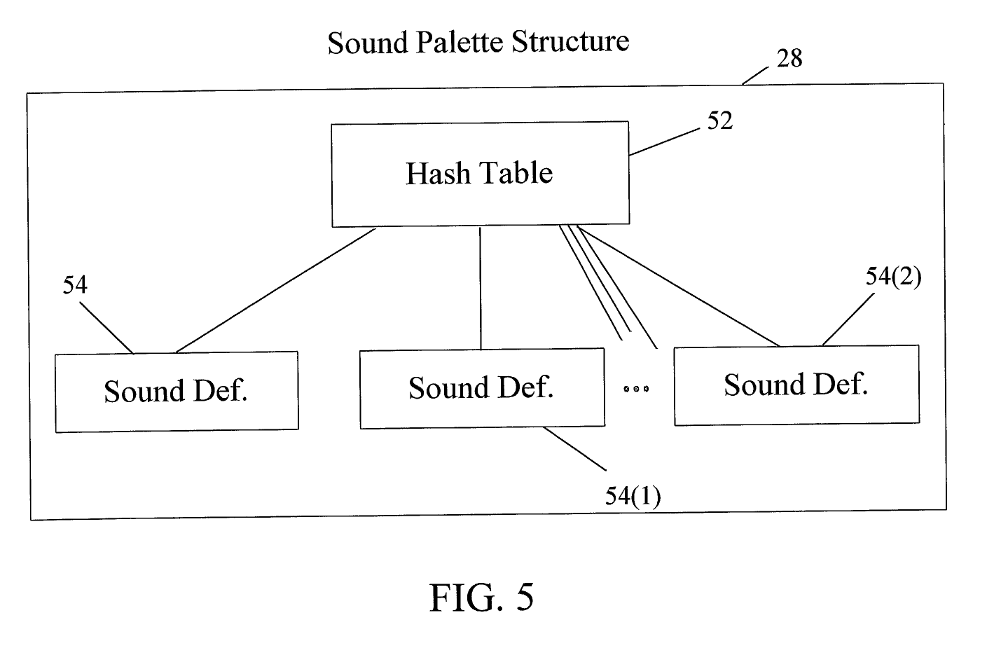

Referring once again to FIG. 2, the sound palette 28 is a set of sound definitions which may be referenced by sound name. A sound name can be represented as a text string. The string may be an argument to a command contained in a command set 48. Referring now to FIG. 5, the sound palette 28 can also be implemented as a hash table, each item of which is a sound definition 54, 54(1), 54(2). Sound names can be hashed to map them to sound definitions. Although a hash table organization is shown in FIG. 5, any data structure that allows sounds to be defined and undefined efficiently can be used.

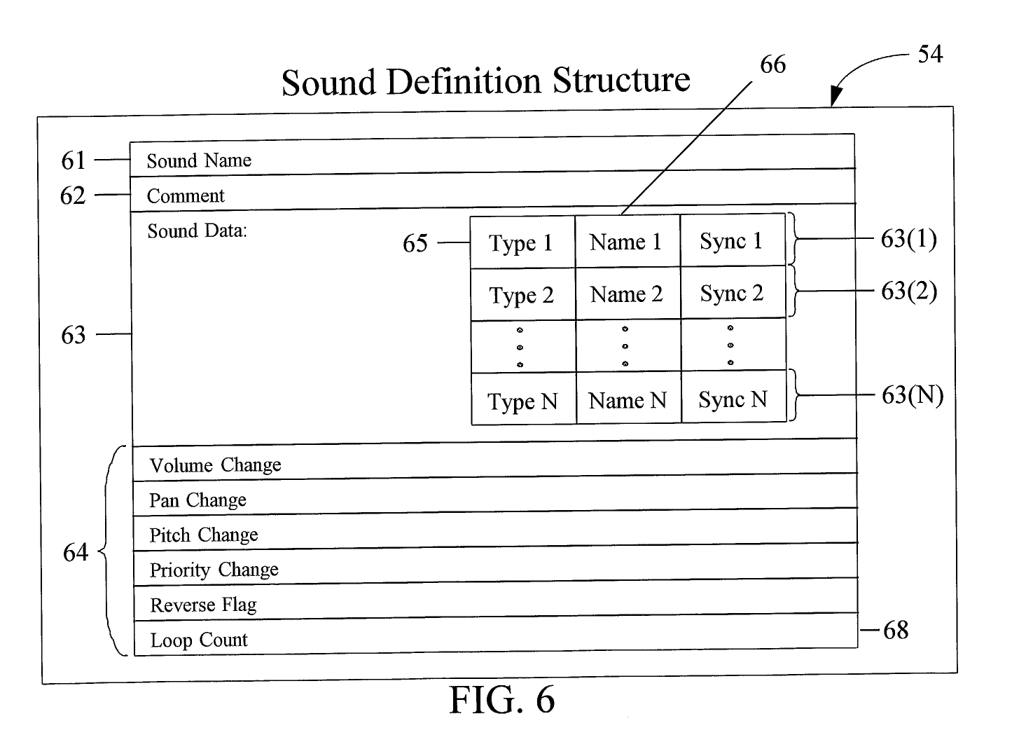

Referring now to FIG. 6, a sound definition 54 consists of at least a sound name 61; a comment string 62; the data required to produce the sound 63; and a set of parameters 64 describing how to modify the sound on playback. For efficiency, the sound name 61 is the same as the name used to look up the sound in the sound palette hash table 52. The comment string 62 may be used to describe the sound to a user when the sound palette 28 is being edited.

The data required to produce the sound 63 is a list of n-tuples 63(1), 63(2), 63(N). In the embodiment shown in FIG. 6, the type 65 refers to either “SOUND” or “FILE”. If the type 65 is “SOUND”, then the name 66 in the n-tuple contains the name of another sound in the palette 28 to be played recursively. If the type 65 is “FILE”, then the name 66 contains the filename of a file that contains the data for making a sound. For efficiency, the file should be in a format usable by the system, although the system may have a number of converters which allow the file to be converted into a native format. For example, the file may contain either a MIDI sound file or digitized waveform data encoded in a format understood by the system or the file may be converted into such a format. The sound file should be stored on the system locally, i.e. in short-term or long-term storage, but the sound file may be stored on a network and retrieved when accessed.

The sync field 67 in the n-tuple may be either “PARALLEL” or “SERIAL”. If the sync 67 is “PARALLEL”, then the sound player 22 will play the sound immediately in parallel with any other playing sounds, if it is capable of doing so. If the sync 67 is “SERIAL”, then the sound player 22 will queue the sound for playing after other previously queued sounds have been played.

The parameters 64 describing how to modify the sound on playback can consist of at least volume, pan change, pitch change, priority change, a reverse flag, and a loop count 68. The sound player 22 uses these parameters 64 when playing the set of queued sounds. Volume can be a numeric value specifying a positive or negative offset from the current overall volume level. Pan change can be a numeric value specifying the balance between the right and left audio channels to be used. For example, negative pan values could move the sound more to the left and positive pan values could move it more towards the right. Pitch change may be a numeric value specifying a positive or negative offset from the recorded pitch of a digitized audio file or the pitch of each note in a MIDI file. Parameter values 64 are added to the current overall volume, pan and pitch settings by the sound player 22 and applied to each queued sound as it is played. Priority change is a numeric value specifying the relative priority of the sound, i.e. which sounds this sound can override. The reverse flag specifies that the sound should be played backwards. Finally, the loop count 68 can specify the number of times that the sound should be repeated. In one embodiment, a value of zero for the loop count indicates that the sound should loop forever.

The sound definition data structure 54 allows complex sounds to be built from simple sound files. Simple sounds may be dynamically sequenced or mixed together to produce more complex sounds that are not actually stored by the system. Sound definitions can be defined recursively in terms of other sound definitions, allowing hierarchies of sounds and a rich auditory display to be constructed. Meaning or relationships between concepts may be represented and conveyed by these complex sounds, for example, all sound definitions representing an action performed on a particular object could contain a simple sound denoting that object.

Using an Auditory Display

When the ADM 20 starts it loads a user-selectable semantic framework 26 which may be used as the only semantic framework or as the root semantic framework of the semantic framework tree. This provides for the sonification of a base set of general concepts. A client 24 may define its own semantic framework to sonify more specific concepts that it requires.

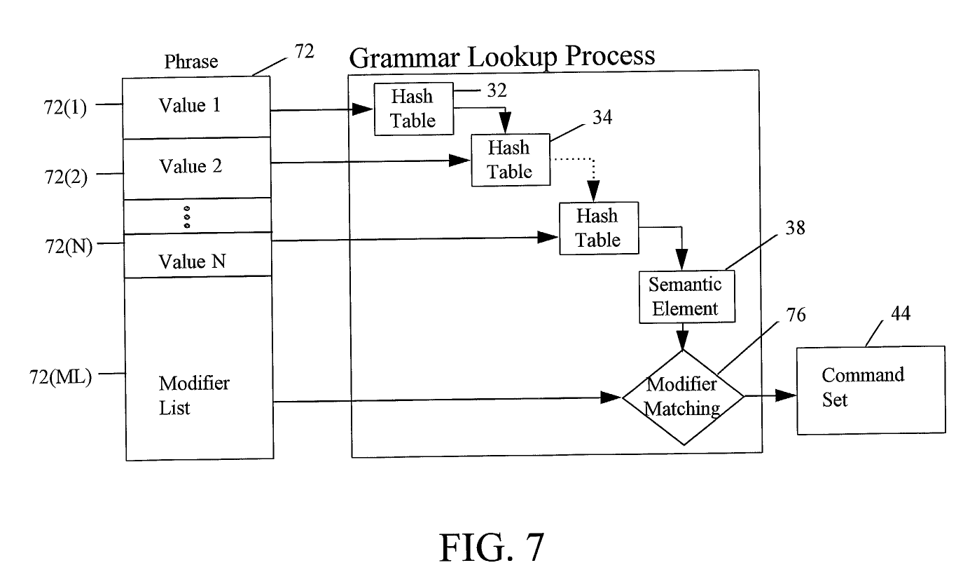

The client 24 sends a message containing a concept set to the ADM 20 whenever it wants to communicate with the user auditorially. Referring to FIG. 7, the concept set 72 contains the identifiers 72(1), 72(2), 72(N) of each dimension of the semantic framework 26 representing the concepts that the client 24 wants to express. When the ADM 20 receives the concept set 72, it will look up the concept set 72 in the semantic framework 26 to determine which command or commands to execute for the concept set 72. The commands may select a sound to be played, which is sent to an audio device 25 for playback. In this case, there is no response message sent back to the client 24 because concept sets 72 are handled asynchronously.

Concept Set Resolution Using the Semantic Framework

The client 24 constructs a concept set 72 out of simple character strings. In one embodiment, the client 24 sends a list of character strings to the ADM 20 as the concept set 72: one for each dimension of the semantic framework 72(1), 72(2), 72(N) and zero or more additional strings containing any modifiers 72(ML). When the ADM 20 receives the concept set 72, it may convert upper-case characters in the strings 72(1), 72(2), 72(N), 72(ML) to lower-case characters so that case is ignored when matching strings. Alternatively, the ADM 20 may use case-sensitive matching. The ADM 20 uses the first string 72(1) contained in the concept set 72 to locate an element in the first dimension of the semantic framework 26. Referring to FIG. 3 and FIG. 7 simultaneously, a simple hashing algorithm may be applied to the first string 72(1) in the concept set 72 for embodiments to find an element in the semantic framework's root hash table 32 for the first dimension of the semantic framework.

If the element is found in the root hash table 32 and it refers to another hash table, then the next string 72(2) in the concept set 72 is hashed to find an element in the second hash table 34. This process continues until either no matching element is found or the element refers to a semantic element 38. Each concept set 72 may be provided with a special “DEFAULT” string. If at any point during the process described above a matching element is not found in a hash table, the special string “DEFAULT” may be hashed to determine a default concept to use. If the default concept is found the process continues as described above, otherwise the concept set 72 is undefined and the ADM 20 is finished processing the message.

If the process described above identifies a semantic element 38, then the concept set 72 is defined. The list of modifier strings 72(ML) in the concept set 72 are compared to the lists of modifiers 42 in the table of the semantic element 38. Comparing modifier sets 76 may be done by counting the number of modifier strings 72(ML) that match and the number that do not match. A best match for the list of modifier strings 72(ML) present in the concept set is determined. In one embodiment, the modifier set in the semantic element table that has the most matches to the modifier set 72(ML) given in the concept set and that does not contain a modifier not present in the concept set 72 is the best match. The command set 48 associated with this modifier set will then be executed. If there is no matching modifier set, then the ADM 20 is finished processing the concept set 72 and no commands will be executed. At this point, the process of using the semantic framework to translate a concept set 72 into an command set 48 is complete.

The ADM 20 may be provided with a special auto-define-semantics mode, in which references to undefined semantic elements 38 cause them to become defined with an empty command set 48. If this mode is enabled, a failed hash lookup will create a new element for the failed hashed value instead of hashing the “DEFAULT” string. If the failed hash lookup is for the last dimension of the semantic framework, then a semantic element 38 with an empty command set 48 is created and associated with that value in the hash table. Otherwise a new, empty hash table is created and associated with the failed hash value. This mode allows a client program 24 to create a framework for a semantic framework 26 having commands assigned later. In some embodiments, a semantic framework editor 27 may be provided to assist with the function of editing the semantic framework 26.

Execution of Command Sets

Once a command set 48 has been identified, each command in the command set 48 should be executed in order of appearance in the semantic element 38. The sound player 22 is used to control sound playback. If a command in the command set 48 cannot be executed, e.g. it refers to an undefined sound, the other commands of the command set 48 should still be executed.

Referring back to Table 1, the Play command uses the sound palette 28 to find the definition of the sound having the name specified in its argument. This can done by hashing the sound name to find an entry in the sound palette hash table 52. If no entry exists for that sound name, then the command does nothing. If it finds an entry, the sound definition 54 is passed to the sound player 22 to be played.

The Stop, Volume, Pan and Pitch commands all send their arguments to the sound player 22. The sound player 22 uses the sound name argument to locate a sound of that name that is currently playing, and performs the indicated operation (stopping the sound, changing its volume, pan or pitch) on that playing sound. In the case of the Volume, Pan and Pitch commands, the numeric offset argument may be represented as a signed integer value that is added to the appropriate value for the playing sound.

The Stop A 11 command causes the sound player 22 to stop all sounds that are currently playing and discard any pending sounds that are waiting to be played.

The Main volume command adjusts the overall volume level used by the sound player 22 by a specified amount. The volume adjustment level may be represented by a signed integer value.

The Sound Player

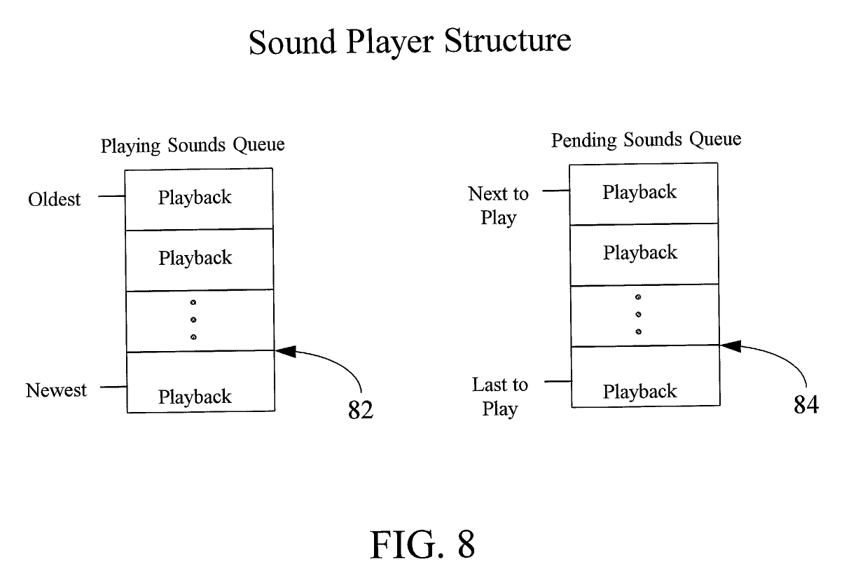

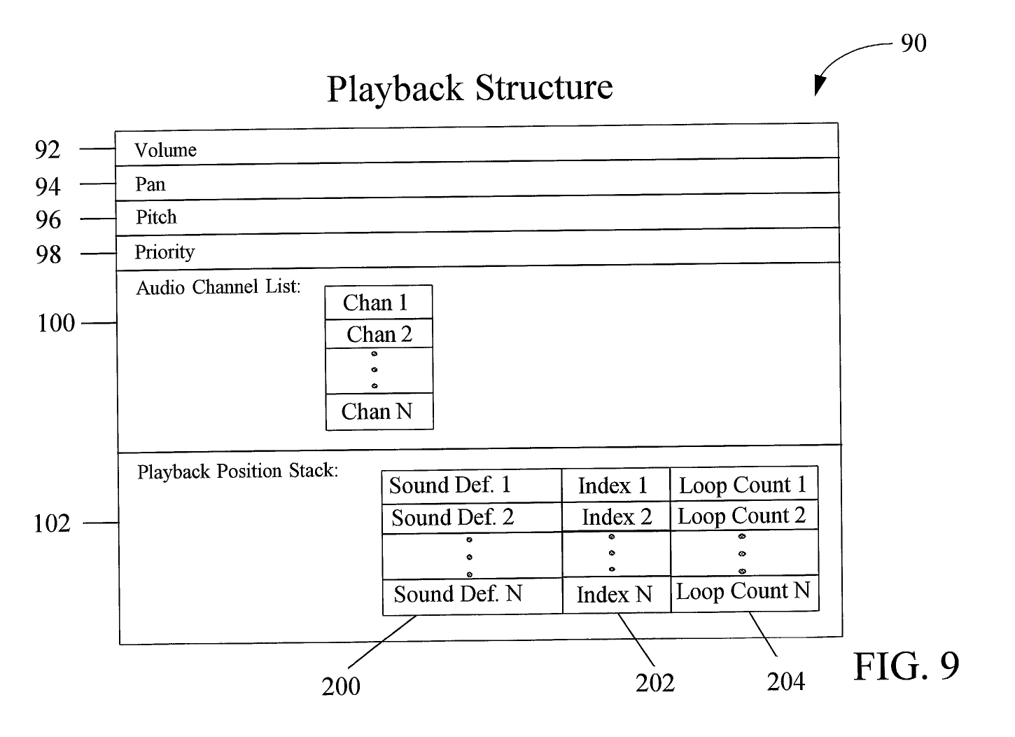

The sound player 22 controls the actual playback of sounds. It interacts with the system's native audio player device 25 to start, stop and control sounds. Referring to FIG. 8, the sound player 22 maintains two queues: one of sounds currently playing 82 and another of pending sounds waiting to be played 84. Referring to FIG. 9, each item in these queues is a playback data structure 90 containing: the current volume 92, pan value 94, pitch value 96; and priority level 98; a list of audio channel identifiers 100; and a playback position stack 102 in which each element contains: a sound definition 200; an index into that definition's sound list 202; and a loop counter 204. A stack is used to provide the ability to nest sounds when an item in a sound list of one sound definition refers to another sound definition. These structures allow the sound player 22 to maintain the current playback state of playing or suspended sounds.

Playing Sounds from a Sound Definition

To play a sound, the sound player first initializes the playback data structure 90 by setting the volume and pan value 92, 94 to the current overall volume and pan settings and the pitch 96 and priority level 98 to zero. The initialized playback structure is then placed at the tail of the currently playing sound queue 82.

In one embodiment, the sound player 22 then executes the “start sound” algorithm as follows. It pushes the sound definition and zero values for the sound list index and loop counter onto the playback position stack 102. The volume 92, pan 94, pitch 96, and priority value 98 from the sound definition on the top of the stack are added to those values in the playback structure 90.

The sound player 22 may then execute the following “check sound” algorithm to play each sound in the sound list of a sound definition. If the loop count 68 in the sound definition 54 on the top of the playback position stack 102 is non-zero and equal to the loop count 204 from the top of the playback position stack 102, that sound has finished playing. A finished sound is popped off the stack 102 and the volume, pan, pitch and priority values from the sound definition 54 in that element are subtracted from those values in the playback structure 90. If the stack 102 is now empty, the sound has completed playing and it is removed from the currently playing queue 82.

If the sound has not finished, the following “play sound” algorithm may be executed. The sound list index 202 from the top of the playback position stack 102 is used to find the n-tuple in the sound data list 63 of the sound definition 54 at the top of the stack to be played. The sound list index 202 at the top of the playback position stack is then incremented. If it is now greater than the length of the sound data list 63, it is reset to zero and the loop count 204 is incremented. If the sync value 67 in the n-tuple found above is “SERIAL”, the list of audio channel identifiers 100 is examined. If it is non-empty, the sound is deferred by moving the playback structure from the currently playing sound queue 82 to the head of the pending sound queue 84. If the list 100 is empty, or the sync value 67 in the n-tuple is “PARALLEL”, the type 65 in the n-tuple is examined. If the type is “SOUND”, the named sound definition 54 is looked up using the sound palette 28, and the “start sound” algorithm is executed with it.

If the type 65 in the n-tuple found above is “FILE”, the named file will be played. An audio channel is allocated from the system audio device 25 to play the sound on, possibly using the “channel stealing” algorithm described below, and a reference to that channel is placed in the list of audio channel identifiers 100. If no channel can be allocated, the sound is deferred by removing the playback structure 90 from the currently playing sound queue 82 and placing it at the head of the pending sound queue 84. If an audio channel was successfully allocated, the contents of the named file are sent to the audio device 25 to be played on the channel allocated to this sound, using the volume, pan and pitch in the playback structure 90, and the “play sound” algorithm is executed again.

The system audio device 25 asynchronously notifies the sound player 22 when a particular audio channel finishes playing the sound data assigned to it. When this occurs, the sound player 22 locates the identifier for that sound channel in a playback structure 90 in the currently playing sound queue 82 and executes the “check sound” algorithm on it, which can in turn invoke the “play sound” algorithm to continue playing sounds in a complex sound. If those algorithms complete and there is still an audio channel available, then the playback structure 90 at the head of the pending sound queue 84 is moved to the end of the currently playing sound queue 82 and the “check sound” algorithm is executed on it. This ensures that all available audio channels will be used to play sounds that should be played in parallel, and that sounds to be played serially with other sounds will be started when the sound preceding them finishes playing.

Channel Stealing Algorithm

The sound player 22 may have only a limited number of audio channels on which it can play sounds. The number of channels available will typically depend on the capabilities of the system hardware. Thus, there is a limit to the number of sounds that may be simultaneously played. If the sound player 22 needs to play a sound and no audio channel is available, it will attempt to free up a channel using a method which will be referred to as “channel stealing.”

When it needs to steal a channel, the sound player 22 will search the queue of playing sounds 82 for the one with the lowest priority that is playing at the lowest volume and has been playing the longest. If the priority of that playing sound is greater than that of the new sound to be played, no channel can be stolen. The new sound is placed at the head of the pending sound queue 84 so that it will be started as soon as a channel becomes available. Otherwise, the playing sound is stopped and removed from the currently playing queue 82. If that sound was looping, it is placed at the head of the pending sound queue 84 so that it will continue looping when another channel becomes available.

Creating and Modifying Sound Palettes

Sound palettes may be created using a special client program that allows a user to create sound definitions. In one embodiment, the client uses a Graphical User Interface (GUI) to allow the user to create or delete entire sound palettes, to create or modify or delete sound definitions within a sound palette, and to manage the storage of sound palettes within the system.

Using the sound palette editing client 29, the user can locate and select sound files from system storage and associate the various parameters of a sound definition with those files. It provides means of constructing sound lists, assigning names to sound definitions, and setting or modifying all of the parameters of a sound definition which are described above.

Creating and Modifying Semantic Frameworks

Semantic frameworks may be created in two ways: by using a special semantic framework editing client program 27, or by using the auto-define-semantics mode described above. The semantic framework editing client allows the user to create, modify or delete semantic frameworks and to manage the storage of semantic frameworks within the system. The user may specify the number of dimensions in a semantic framework and label each one with a text string. They may create semantic elements 3 8 with their associated modifier sets 46 and command sets 48, and associate those elements with specific combinations of concepts within the semantic framework. The user may create, modify or delete any of the parameters of a semantic framework or semantic element described above.

The user can also change the parameters of all semantic elements which share a particular instance of a concept in one dimension of the semantic framework. Referring to FIG. 1 as an example, the semantic framework editor would allow the client to add a Play command to all semantic elements that are defined using the verb “move” and any noun or adjective. Alternatively, the volume of all defined semantic elements using the noun “window” and any verb or adjective could be modified. This permits the user to create consistencies across concepts.

The sound palette editing client 29 and the semantic framework editing client 27 could be two separate programs, or could be combined into a single program. Likewise, sound palettes 28 and semantic frameworks 26 could be stored as two separate data files, or could be combined into a single file. In the preferred embodiment, the sound palette editor and semantic framework editor are combined in a single program, and the semantic frameworks and sound palettes are stored as separate files.

Application Programming Interface Specification

The ADM 20 may provide an Application Programming Interface comprising methods for connecting to the ADM 20, defining a semantic framework, defining a sound palette, and obtaining information about the currently defined semantic framework or sound palette. In one embodiment, the API provided by the ADM 20 includes at least the following commands.

MESSAGE: Initialize

Establishes a connection between the client program and the ADM. Once connected, the global semantic framework and sound palette, which are pre-defined by the system user, are available to the client program.

MESSAGE: Shutdown

Disconnects the application from the ADM, releasing any resources that the ADM has maintained for the client program.

MESSAGE: Activate

Accepts a Boolean parameter, which is TRUE to enable audio output from the ADM, or FALSE to disable it. This may be used to temporarily disable the Auditory Display without destroying all the data used to produce it.

MESSAGE: ProcessConceptSet

Accepts a concept set from the client program and renders it in sound. This is the message the client sends whenever it wants to represent information using the ADM.

MESSAGE: ReadSemanticFramework

Reads a stored semantic framework from a disk file or files, making it the layered semantic framework local to the client program. A parameter may be used to read in the global semantic framework instead of a local one.

MESSAGE: WriteSemanticFramework

Writes the currently-defined layered semantic framework local to the client program to a file or files on disk to store them for later. This allows a client to save a semantic framework that it has constructed for its own use. A parameter may be used to write the global semantic framework instead of the local one, or to combine both the global and local semantic framework together into a single semantic framework when writing it out.

MESSAGE: GetSemanticElement

Obtains a semantic element from the local or global semantic framework given a particular concept set.

MESSAGE: SetSemanticElement

Defines a semantic element in the local or global semantic framework given the information for a semantic element and the concept set to associate it with. It may also be used to undefine a semantic element so that it is no longer in the semantic framework.

MESSAGE: EnumerateSemanticElements

Allows the caller to enumerate all the semantic elements defined in the semantic framework, or in any dimension of the semantic framework.

MESSAGE: ReadSoundPalette

Reads a stored sound palette from a disk file or files, making it the layered sound palette local to the calling application.

MESSAGE: WriteSoundPalette

Writes the currently-defined layered sound palette local to the calling application to a file or files on disk to store them for later. This allows an application to save a sound palette that it has constructed for its own use.

MESSAGE: GetPaletteEntry

Obtains information from the sound palette about a particular sound. May also be used to enumerate all sounds in the sound palette.

MESSAGE: SetPaletteEntry

Defines information for a particular sound in the sound palette. It may also be used to undefine a sound so that it is no longer in the sound palette.

MESSAGE: PlaySound

Causes a particular sound from the sound palette or an arbitrary sound file stored on disk to be played immediately and in parallel with any other sounds.

MESSAGE: StopAllSounds

Stops any and all sounds that are currently playing.

MESSAGE: SetVolume

Sets the overall volume level for playback of all sounds. Individual sound volume settings or changes will be made relative to this value.

If the invention is provided as computer software, it may be written in any high-level programming language which supports the data structure requirements described above, such as C, C++, PASCAL, FORTRAN, LISP, or ADA. Alternatively, the invention may be provided as assembly language code. The invention, when provided as software code, may be embodied on any non-volatile memory element, such as floppy disk, hard disk, CD-ROM, optical disk, magnetic tape, flash memory, or ROM.

Having described certain embodiments of the invention, it will now become apparent to one of ordinary skill in the art that other embodiments incorporating the concepts of the invention may be used. Therefore, the invention should not be limited to certain embodiments, but rather should be limited only by the spirit and scope of the following claims.

What is claimed is:

1. A method for representing information auditorially, the method comprising the steps of:
(a) mapping a concept set representing information to a semantic element stored in a memory element;
(b) using the mapped semantic element to select a command that identifies a sound to be output; and
(c) executing the command to output the identified sound.

2. The method of claim 1 wherein step (a) comprises mapping a concept set representing information to an element of a semantic framework having more than one dimension.

3. The method of claim 1 further comprising before step (a) the step of accepting a concept set representing information from a device.

4. The method of claim 3 wherein the device comprises a computer.

5. The method of claim 1 further comprising before step (a) the steps of:
receiving information from a device, the information to be represented auditorially; and
transforming the received information into a concept set representing information.

6. The method of claim 1 wherein step (b) further comprises applying a modifier to the semantic element to select a command identifying a sound to be output.

7. The method of claim 1 wherein step (a) further comprises:
(a-a) accepting a concept set representing information from a device, the concept set comprising a value and a modifier; and
(a-b) retrieving from a hash table stored in a memory an entry identifying a semantic element, the entry identified by the value of the concept set.

8. The method of claim 1 further comprising the step of creating semantic elements responsive to the execution of a client program.

9. The method claim 1 wherein step (c) further comprises executing the command to output the identified sound contemporaneously with a plurality of other sounds in order to produce more complex sounds.

10. An apparatus for representing information auditorially comprising:
a mapping unit that accepts as input a concept set representing information and outputs a command identifier selecting a command to be executed based on the input concept set;
a command execution unit that accepts as input the command identifier and executes the selected command to output a sound identified by the command.

11. The apparatus of claim 10 further comprising a semantic element data structure stored in a memory element, the semantic element data structure used by said mapping unit to map an input concept set representing information to a command to be executed.

12. The apparatus of claim 11 wherein said semantic element data structure comprises at least one hash table.

13. The apparatus of claim 10 further comprising a sound player, said sound player accepting a play request input from said command execution unit and outputting audio data.

14. The apparatus of claim 13 wherein said sound player outputs audio data to an audio device for auditory representation.

15. The apparatus of claim 13 further comprising a sound palette stored in a memory element, said sound palette accepting sound identifiers from, and returning sound definitions to, said command execution unit and said sound player.

16. The apparatus of claim 15 wherein said sound palette comprises at least one hash table.

17. The apparatus of claim 11 further comprising a semantic framework design unit for editing the semantic element data structure.

18. The apparatus of claim 17 wherein said semantic element data structure comprises an n-dimensional array and said semantic framework design unit edits all semantic elements along a first dimension of the array.

19. The apparatus of claim 14 further comprising a sound palette design unit for editing the sound definitions stored by said sound palette.

20. An article of manufacture having computer-readable program means for representing complex information auditorially embodied therein, comprising:
computer-readable program means for mapping a concept set representing information to a semantic element stored in a memory element;
computer-readable program means for using the mapped semantic element to select a command that identifies a sound to be output; and
computer-readable program means for executing the command to output the identified sound.
